(19) United States
(12) Patent Application Publication
(10) Pub. No.: US 2003/0218327 A1
(43) Pub. Date: Nov. 27, 2003

(54) Book for simultaneous viewing of text and graphics

(76) Inventors: Felice Yager, Cambridge, MA (US); Jane Grossman, Cambridge, MA (US)

Correspondence Address: BROMBERG & SUNSTEIN LLP, 125 SUMMER STREET, BOSTON, MA, 02110-1618, US

(21) Appl. No.: 10/152,449

(22) Filed: May 21, 2002

(51) Int. Cl. B42D 3/00

(52) U.S. Cl. 281/31

(57) ABSTRACT

A book having a cover, a plurality of textual pages physically associated with the cover, and a plurality of distinct graphical pages. The textual pages have a plurality of sections, each section corresponding to one of the graphical pages. A pocket having a transparent window is foldably attached to the cover. The graphical pages are disposed in the pocket, and when the pocket is folded out, a selectable one of the graphical pages may be viewed through the transparent window simultaneously with the section of text to which the selectable one of the graphical pages corresponds.

### TECHNICAL FILED AND BACKGROUND ART

It is known in the prior art to provide books having descriptive text that is supplemented by additional materials that are stored with such books. For example, a series of guides, published by Virgin Publishing, Ltd., London, England includes a supplementary pocket, attached to a book jacket, that is used to store a folded map. A similar type of book is published by Metropolis International (UK) Limited, London England. To use the map stored in the pocket, it is removed and unfolded.

U.S. Pat. No. 5,851,031, issued for an invention of Golson, describes a book having a flap attached to a book jacket but provides a single side of information (such as a key of symbols, for example) available to a user while reading the text of the book.

### SUMMARY OF THE INVENTION

In a first embodiment of the invention there is provided a book having a cover, a plurality of textual pages physically associated with the cover, and a plurality of distinct graphical pages. The textual pages have a plurality of sections, each section corresponding to one of the graphical pages. A pocket having a transparent window is foldably attached to the cover. The graphical pages are disposed in the pocket and a selectable one of the graphical pages may be viewed through the transparent window simultaneously with the section of text to which the selectable one of the graphical pages corresponds.

In related embodiments of the invention, the textual pages may be perfect-bound, cloth-bound, or spiral-bound to the cover. The textual pages may be attached to an exterior binding and the cover is a jacket removably attached to the binding. Each of the graphical pages may have a plastic surface. Each of the textual pages may have a common thickness, with each of the graphical pages having a thickness greater than the common thickness. The pocket may include a sealing means for securing the graphical pages within the pocket. The sealing means may include for example, a string or magnetic fastener for closing an opening of the pocket, or an adhesive tape placed across an opening of the pocket. Each section of text and its corresponding graphical page may have a common identifier. The common identifier may include a color code.

In another related embodiment, at least one of the graphical pages includes a map of a location described in a corresponding section of text. In other embodiments, at least one graphical page may illustrate an assembly of components, a gardening configuration, a landscaping configuration, an architectural configuration, game play, a craft activity, or a cooking activity described in a corresponding section of text. In yet further embodiments, at least one graphical page may depict a fine art work or include scientific material, such as material pertaining to anatomy, astronomy, or geometry.

### BRIEF DESCRIPTION OF THE DRAWINGS

The foregoing features of the invention will be more readily understood by reference to the following detailed description, taken with reference to the accompanying drawings, in which:

FIG. 1 is a perspective view of an embodiment of the invention in an open position showing how simultaneous access both to a map and descriptive text may be provided to a user;

FIG. 2 is a perspective view of the embodiment of FIG. 1, partially closed; and

FIG. 3 is a perspective view of the embodiment of FIG. 1 in a closed position.

### DETAILED DESCRIPTION OF SPECIFIC EMBODIMENTS

Definitions. As used in this description and the accompanying claims, the following terms shall have the meanings indicated, unless the context otherwise requires:

The term “textual page” as used herein means sheets that collectively include text, but may also optimally include graphical material.

The term “graphical page” as used herein means a sheet that includes a drawing or other pictorial representation but may also optimally include textual material.

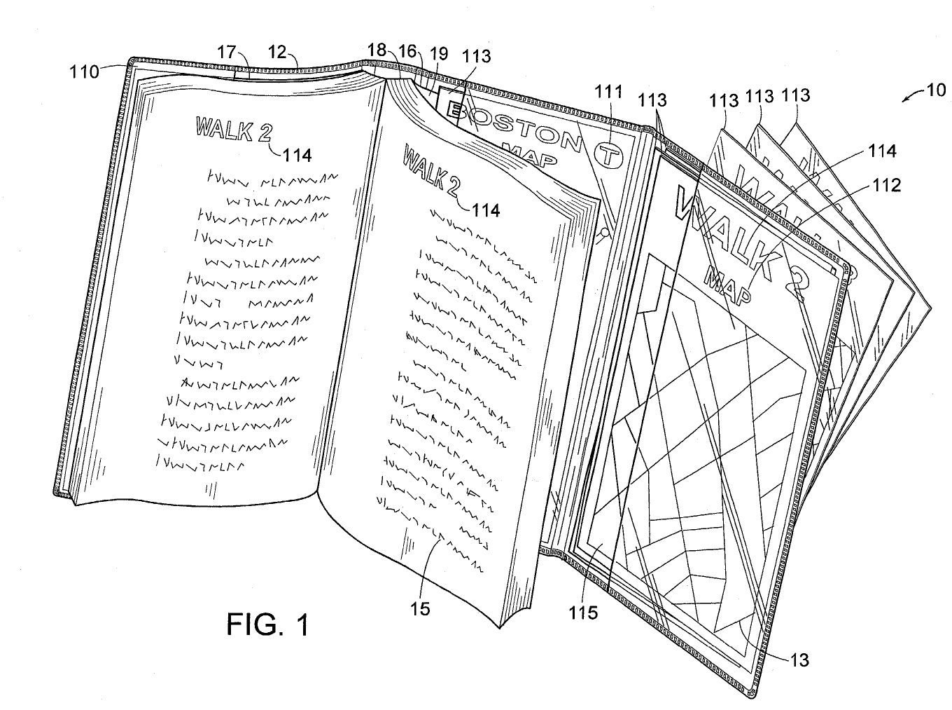

In accordance with one embodiment of the invention, FIG. 1 is a perspective view of a book 10 in an open position showing how simultaneous access both to a graphical depiction, such as a map, and descriptive text may be provided to a user. A user of the book 10 can conveniently browse through text 15 and view distinct graphical pages 113 without having to flip back and forth between textual pages 15. Moreover, the user can select for viewing one of a plurality of interchangeable graphical pages 113, and is not limited, for example, to a single graphical foldout.

The book 10 includes a cover 12 physically associated with the plurality of textual pages 15. The cover 12 may be directly attached to the textual pages 15. For example, the textual pages 15 can be perfect bound, cloth bound, or spiral bound to the cover 12, which may be a hardcover or a softcover.

Alternatively, the cover 12 may be a book jacket covering an exterior binding 16 to which the textual pages 15 are attached. The book jacket typically spans the exterior binding 16, including the spine 18, front side 17, and back side 19 of the exterior binding 16, and is easily installed or removed from the binding 16. The book jacket may, for example, include pockets 110 and 111 into which the front 17 and back side 19 edges can be inserted, respectively. The book jacket may be made of plastic, leather, paper, or other suitable material.

Foldably attached to the front or back of cover 12 is a pocket 13. The pocket 13 is shaped so as to form a pouch having at least one open side into which one or more distinct graphical pages 113 can be disposed. The pocket 13 may be a foldable extension of the cover 12, or mechanically hinged to the cover 12. The pocket 13 may, for example, be taped, glued, sewn, or spiral bound to the cover 12.

In a typical embodiment, the pocket 13 spans the height of the cover 12 with the opening of the pocket 13 located adjacent to the interior back side of the cover 12, facing the spine 18, when the pocket 13 is folded out. If the pocket 13 folds inward, the graphical pages can then be sized such that they can be removed from the pocket 13 only when the pocket 13 is unfolded. In other embodiments, the opening of the pocket 13 may face the top, bottom, or outer edge of the pocket 13.

The pocket 13 may include a sealing means for securing the graphical pages within the pocket. Sealing means may include, without limitation, a snap, a clasp, a lock, a clip, a string fastener, a magnetic fastener, or a tape placed across the opening of the pocket 13. Tape may be adhesive tape or a tape commonly sold under the trademark “Velcro.”

The pocket 13 includes a transparent window 112, such that when the pocket 13 is folded out, as shown in FIG. 1, the transparent window 112 is juxtaposed with the textual pages 15. By placing a selectable one of the graphical pages 113 in the pocket 13 against the transparent window 112, a user can simultaneously view both the selected graphical page 115 and a section of text to which the selected graphical page 115 corresponds. Graphical pages 113 that are not being viewed can be stored in the pocket 13 beneath the graphical page 115 currently selected.

The transparent window 112 may span the height of the pocket 13, or alternatively, a portion of the pocket 13. The transparent window 112 may be, for example, a plastic material or a cut out portion of the pocket 13. Informative indicia may be placed on those sections of the pocket 13 that are not transparent. Informative indicia may include, without limitation, a legend for a map, various advertisements, or a table of contents for the associated textual pages.

Since the graphical pages 113 can be removed or inserted into the pocket 13 numerous times over the life of the book, the graphical pages 113 may advantageously be made more durable than the textual pages 15. For example, each graphical page 113 may have a thickness greater than the common thickness of each of the textual pages 15. Each of the graphical pages 113 may also have a plastic surface.

A section of text 15 may correspond to a particular graphical page 113. So that a user may easily select for viewing a graphical page 113 that corresponds to a particular section of text 15, both the section of text 15 and the corresponding graphical page 113 may include a common identifier 114. The common identifier may include, for example, a color code, text, a number, or a graphic symbol associated with, for instance, the subject of the text 15. A user viewing a certain section of text 15 can thus look at the common identifier 114 associated with the section of text 15, and select for viewing the graphical page 113 having the same identifier 114.

In the illustrated embodiment, book 10 is a walking guide book, with each section of text 15 describing a specific walk, and each graphical page 113 including a map of a location described in its corresponding section of text 15. A user viewing a textual section 15 selects a graphical page 115 that includes a map, based on the identifier (Walk 2) of the section of text being viewed, and places the graphical page 115 in the pocket 13 so as to be adjacent to, and viewable through, the transparent window 112. As described above, the remaining graphical pages 113 may then be stored in the pocket 13 beneath the selected graphical page 115 (in FIG. 1, additional graphical pages 113 are also shown external to the book 10 for illustrative purposes). A user of the book 10 can thus simultaneously view both descriptive text 15 and a graphical page (map) 115 regarding a walk, without, for example, having to pull out and hold a foldable map while simultaneously holding/reading from the book. If the user then desires to go on a different walk described by another section of text 15, a new graphical page 113 may be selected based on the section's identifier and placed in the pocket 13 adjacent to, and viewable through, the transparent window 112.

The graphical pages 113 may provide drawings or other pictorial representations associated with a wide variety of subjects described in a corresponding section of text 15. For example, and not meant to be limiting, at least one of the graphical pages 113 may include a map of a location, such as in the embodiment shown in FIG. 1. At least one of the graphical pages may include scientific material. For example, at least one of the graphical pages 113 may include anatomical material, such as, but not limited to, the structure of a plant or animal described in a corresponding section of text 15. Scientific material may also include, without limitation, astronomy or geometry. At least one of the graphical pages 113 may illustrate assembly of components, so that a user can, for example, simultaneously read instructions in the text on how to assemble components while viewing a plan, drawing, or picture of how the components are to be put together. At least one of the graphical pages 113 may illustrate a gardening configuration described in a corresponding section of text 15. The illustration may include, for example, a plan, photograph, a drawing or the like showing the arrangement of items in a garden. Similarly, at least one of the graphical pages 113 may illustrate a landscape or architectural configuration. At least one of the graphical pages 113 may depict fine artwork, which may be, for example, painting, sculpture, or other creative work. At least done of the graphical pages may illustrate game play described in a corresponding section of text 15. Game play may include, for example, sport activities, card games, or boardgames such as chess, checkers, or go. At least one of the graphical pages 113 may illustrate a craft activity described in a corresponding section of text 15, such as, but not limited to knitting, woodworking, cooking, or pottery.

With regards to those embodiments of the invention that include a book jacket, at least one of the graphical pages 113 may also be inserted into pockets 110 and/or 111. In such embodiments, the graphical page 113 in pockets 110 or 111 may be covered while reading text 15, such that the user may not be able to simultaneously read a section of text 15 and view the graphical page 113.

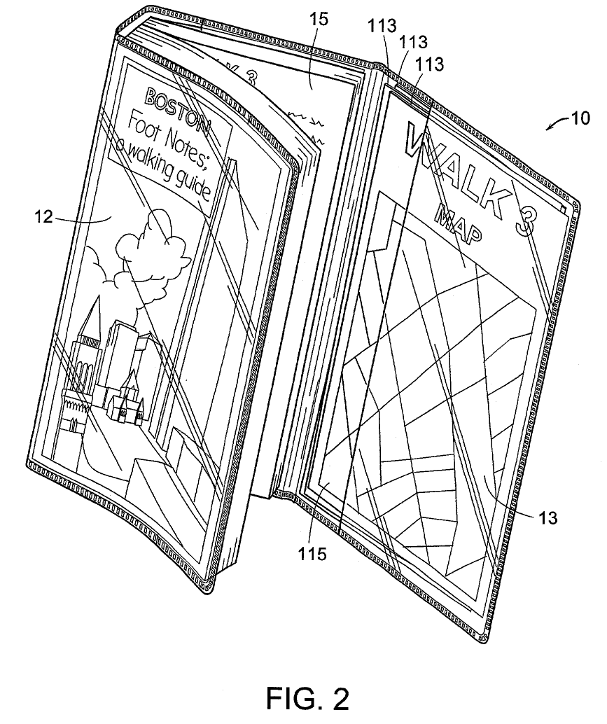

FIG. 2 shows the book 10 partially closed, in accordance with an embodiment of the invention. As can be seen in this view, the front of the cover 12 may include printed information such as the title of the book 10, artwork, the author, and the publisher. The back and spine of cover 12 may similarly include printed information.

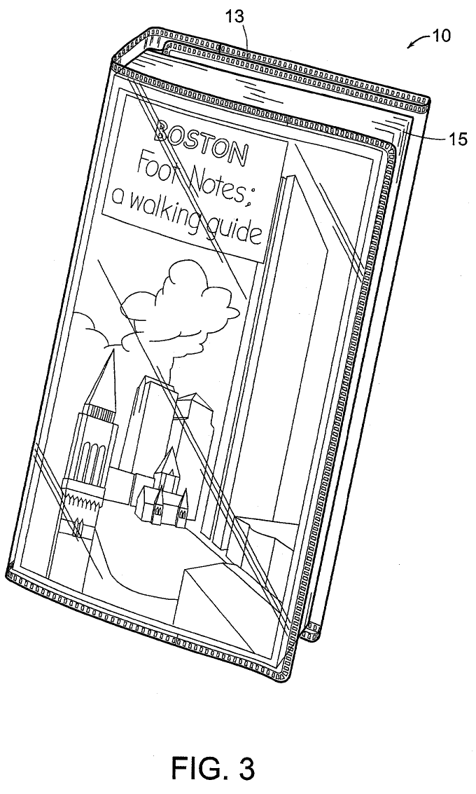

FIG. 3 shows the book 10 when the pocket 13 is in the folded position, in accordance with one embodiment of the invention. Pocket 13 folds inward towards the interior of the cover 12. In this position, the graphical pages 113 are obscured by the textual pages 15 and are no longer viewable. In an alternative embodiment, the pocket 13 may fold outward towards the exterior of the cover 12. The selected graphical page 115 (see FIG. 1) will thus still be viewable through the transparent window 112 when the pocket 13 is in the folded position. The pocket 13 may advantageously fasten to the cover 12 to prevent the pocket from flapping open. Fastening means may include, without limitation, a snap, a clasp, a lock, a clip, a string fastener, a magnetic fastener, or a tape placed across pocket 13 and cover 12. Tape may be adhesive tape or a tape commonly sold under the trademark “Velcro.”

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A book comprising:
a cover;
a plurality of distinct graphical pages;
a plurality of textual pages physically associated with the cover, the textual pages having a plurality of sections, each section corresponding to one of the plurality of graphical pages; and
a pocket, foldably attached to the cover, the pocket having a transparent window, wherein the plurality of graphical pages are disposed in the pocket and a selectable one of the graphical pages may be viewed through the transparent window simultaneously with the section of text to which the selectable one of the graphical pages corresponds.

2. The book according to claim 1, wherein the textual pages are perfect-bound to the cover.

3. The book according to claim 1, wherein the textual pages are cloth-bound to the cover.

4. The book according to claim 1, wherein the textual pages are spiral-bound to the cover.

5. The book according to claim 1, wherein the textual pages are attached to an exterior binding and the cover is a jacket removably attached to the binding.

6. The book according to claim 1, wherein each of the graphical pages has an external plastic surface.

7. The book according to claim 1, wherein each of the textual pages has a common thickness and each of the graphical pages has a thickness greater than the common thickness.

8. The book according to claim 1, wherein the pocket includes a sealing means for securing the graphical pages within the pocket.

9. The book according to claim 8, wherein the sealing means includes a string fastener for closing an opening of the pocket.

10. The book according to claim 8, wherein the sealing means includes a magnetic fastener for closing an opening of the pocket.

11. The book according to claim 8, wherein the sealing means includes a tape placed across an opening of the pocket.

12. The book according to claim 1, wherein each section of text and its corresponding graphical page has a common identifier.

13. The book according to claim 12, wherein the common identifier includes a color code.

14. The book according to claim 1, wherein at least one of the graphical pages includes a map of a location described in a corresponding section of text.

15. The book according to claim 1, wherein at least one of the graphical pages includes anatomical material described in a corresponding section of text.

16. The book according to claim 1, wherein at least one of the graphical pages illustrates assembly of components described in a corresponding section of text.

17. The book according to claim 1, wherein at least one of the graphical pages illustrates a garden configuration described in a corresponding section of text.

18. The book according to claim 1, wherein at least one of the graphical pages illustrates a landscaping configuration described in a corresponding section of text.

19. The book according to claim 1, wherein at least one of the graphical pages depicts a fine artwork described in a corresponding section of text.

20. The book according to claim 1, wherein at least one of the graphical pages illustrates an architectural configuration described in a corresponding section of text.

21. The book according to claim 1, wherein at least one of the graphical pages illustrates game play described in a corresponding section of text.

22. The book according to claim 1, wherein at least one of the graphical pages illustrates a craft activity described in a corresponding section of text.

23. The book according to claim 1, wherein at least one of the graphical pages illustrates a cooking activity described in a corresponding section of text.
